(19) United States
(12) Patent Application Publication
(10) Pub. No.: US 2017/0332672 A1
(43) Pub. Date: Nov. 23, 2017

(54) Gas Infusing Devices and Gas Manifolds for Batch Beverage Machines

(71) Applicant: Cornelius, Inc., Osseo, MN (US)

(72) Inventors: Tomasz K. Kasprzycki, Carpentersville, IL (US); Michael Kurtz, St. Charles, IL (US)

(73) Assignee: Cornelius, Inc., Osseo, MN (US)

(21) Appl. No.: 15/491,217

(22) Filed: Apr. 19, 2017

Related U.S. Application Data
(60) Provisional application No. 62/383,674, filed on Sep. 6, 2016.
(60) Provisional application No. 62/367,928, filed on Jul. 28, 2016.
(60) Provisional application No. 62/339,528, filed on May 20, 2016.

(51) Int. Cl. A23L 2/54; B01F 15/02; B01F 3/04; B01F 15/00; B01F 3/02

(52) U.S. Cl. CPC A23L 2/54; B01F 15/00422; B01F 3/028; B01F 3/04808; B01F 15/026; B01F 15/00779; B01F 15/00162; A23V 2002/00; B01F 2003/049; B01F 2215/0022

(57) ABSTRACT

A beverage machine has a gas dissolution assembly that includes a pressure vessel having an open end and a top cap that couples with the open end of the pressure vessel. The top cap has a gas inlet through which a gas to be infused into the beverage flows. A clamping mechanism clamps the top cap onto the open end of the pressure vessel. A gas infusing device that is coupled to the gas inlet has a porous element that infuses the gas into the beverage.

### CROSS-REFERENCE TO RELATED APPLICATIONS

The present application is based on and claims priority to U.S. Provisional Patent Application Ser. Nos. 62/339,528 (filed on May 20, 2016), 62/367,928 (filed on Jul. 28, 2016), and 62/383,674 (filed on Sep. 6, 2016), the disclosures of which are incorporated herein by reference.

### FIELD

The present disclosure relates to gas infusing devices and gas manifolds for beverage machines.

### BACKGROUND

The following U.S. patent and U.S. patent applications are incorporated herein by reference in entirety.

U.S. Pat. No. 9,114,368 discloses a batch carbonation apparatus having a housing that defines a vessel cavity. The housing includes an agitation mechanism. The pressure vessel includes a cap that has a CO2 inlet and a CO2 outlet. The pressure vessel also includes a seal. The pressure vessel is moveable into and out of the vessel cavity. A locking mechanism is provided and is attached to the agitation mechanism to removably lock the cap and seal relative to the pressure vessel. A CO2 source is connected to a plurality of valves where each valve has a differing pressure. A selection toggle is attached to the housing. A control mechanism is coupled to the plurality of valves. A user selects a desired carbonation level using the selection toggle and CO2 is introduced to the pressure vessel at a specified pressure wherein the agitation mechanism agitates liquid within the pressure vessel forming a carbonated beverage having a selected carbonation level.

U.S. Patent Application Publication No. 2014/0302212 discloses a carbonation apparatus that includes a pressure vessel having a cap with a gas inlet and a gas outlet. The carbonation device also includes a seal. The seal includes a labyrinth preventing contact of a liquid within the pressure vessel with the cap during a carbonation process. A locking mechanism removably locks the cap and seal and antifoam device relative to the pressure vessel.

U.S. patent application Ser. No. 15/138,643 filed on Apr. 26, 2016 discloses a batch dissolution assembly comprises a pressure vessel having an open end and being configured to contain a beverage to be carbonated and a flexible seal that covers the open end of the pressure vessel. A closure mechanism for the pressure vessel comprises a retainer configured to receive and retain the open end of the pressure vessel, a top cap, and an over-center clamping mechanism that is configured to clamp the top cap onto the open end of the pressure vessel so that the flexible seal member is sandwiched between the top cap and the open end of the pressure vessel.

U.S. Patent Application Publication No. 2017/0055552 discloses a method and apparatus for inline injection of gases into flowing liquid.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a gas dissolution assembly includes a pressure vessel having an open end and being configured to contain a beverage into which a gas is infused. A top cap couples with the open end of the pressure vessel. The top cap has a gas inlet through which a gas to be infused into the beverage flows. A clamping mechanism clamps the top cap onto the open end of the pressure vessel. A gas infusing device coupled to the gas inlet has a porous element that infuses the gas into the beverage.

In certain examples, a method of infusing a gas in a beverage includes receiving a beverage into which a gas is infused in a pressure vessel having an open end; coupling a top cap to the open end with a clamping mechanism, the top cap having a gas inlet through which the gas flows; and infusing the gas into the beverage with a gas infusing device that is coupled to the gas inlet and has a porous element configured to infuse the gas into the beverage.

In certain examples, a method of calibrating a beverage machine that infuses a gas in a beverage receiving a first gas and a second gas with an inlet gas manifold having a first inlet valve that receives the first gas, a second inlet valve that receives the second gas, and an outlet gas valve configured to dispense the gas to be infused in the beverage; opening the first gas valve; sensing, with an inlet pressure sensor, the pressure of the first gas; closing the first gas valve; opening the second gas valve; sensing, with the inlet pressure sensor, the pressure of the second gas; closing the second gas valve; and controlling, with a controller, the first inlet valve, the second inlet valve, and the outlet valve based on the pressure of the first gas sensed by the inlet pressure sensor and the pressure of the second gas sensed by the inlet pressure sensor.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is an example beverage machine for batch beverages with an access door in an open position.

FIG. 2 is a rear perspective view the beverage machine of FIG. 1 without a rear cover panel.

FIG. 3 is an example pressure vessel and a closure mechanism.

FIG. 4 is a side view like FIG. 3 with an over-center clamping mechanism with a handle in an unclamped position.

FIG. 5 is a side view like FIG. 3 with the over-center clamping mechanism with the handle in a clamped position.

FIG. 6 is a top view like FIG. 3.

FIG. 7 is an exploded view of the example pressure vessel and the closure mechanism of FIG. 3.

FIG. 8 is a schematic diagram of an example beverage machine, an example inlet gas manifold, and an outlet gas manifold.

FIG. 9 is an example inlet gas manifold.

FIG. 10 is an example outlet gas manifold.

FIG. 11 is an example system diagram.

FIGS. 12-16 are alternative examples of pressure vessels and gas infusing devices.

FIG. 17 is an exploded view of an alternative pressure vessel and the closure mechanism.

### DETAILED DESCRIPTION

In the present description, certain terms have been used for brevity, clarity and understanding. No unnecessary limitations are to be inferred therefrom beyond the requirement of the prior art because such terms are used for descriptive purposes only and are intended to be broadly construed. The different apparatuses and methods described herein may be used alone or in combination with other apparatuses and methods. Various equivalents, alternatives and modifications are possible within the scope of the appended claims.

The examples shown in this disclosure can be utilized in combination with the apparatuses and machines disclosed in the above-incorporated U.S. patent application, U.S. patent application Publications, and U.S. patent.

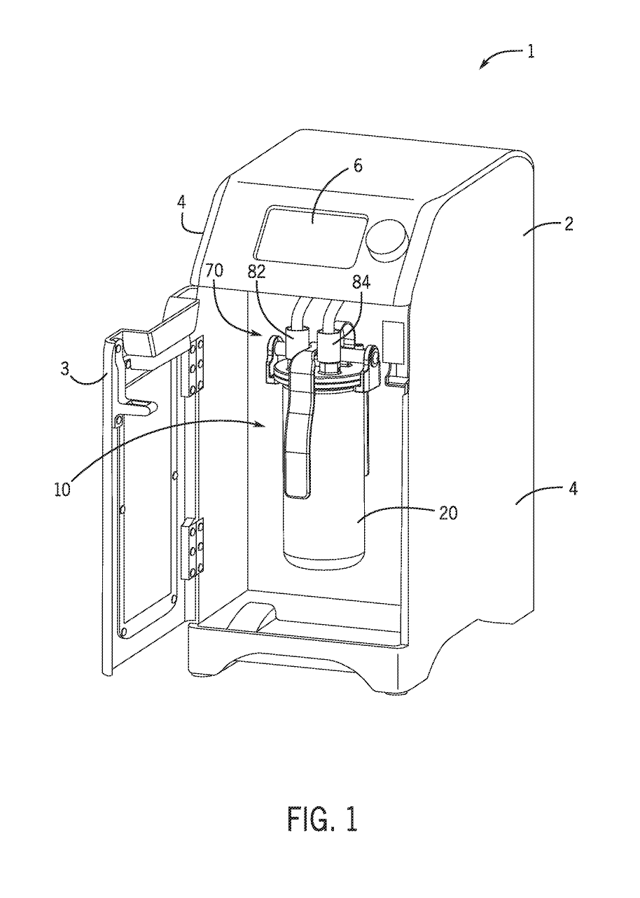

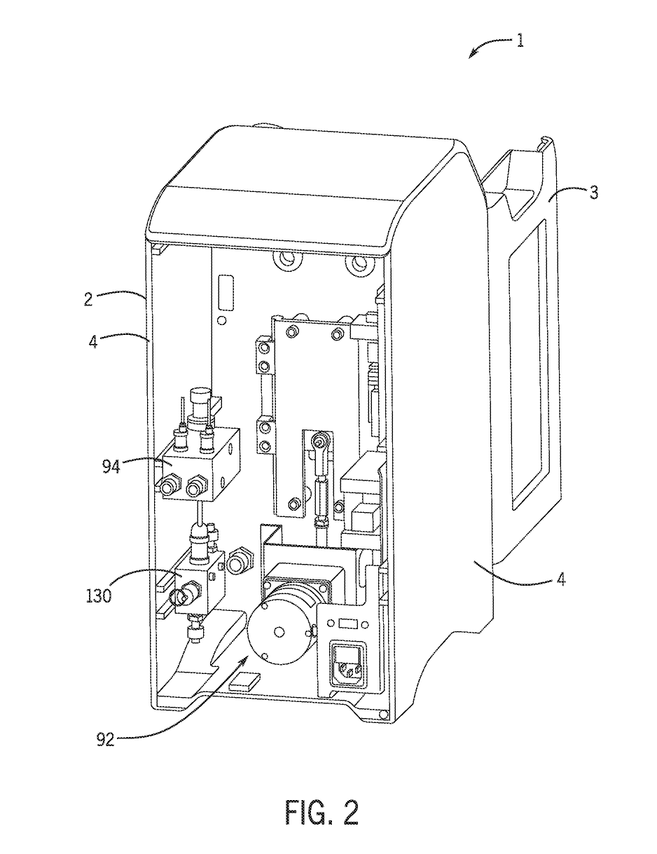

Referring to FIGS. 1-2, a beverage machine 1 includes a housing 2, an user input device 6 configured to receive an input from an operator, and a gas dissolution or infusion assembly 10 configured to dissolve or infuse a gas or mixed gas into a batch or single serve beverage. One having ordinary skill in the art will recognize that the gas dissolution assembly 10 can be configured to dissolve, infuse, and/or inject the gas or mixed gas into the batch or single serve beverage. The housing 2 includes an access door 3, side panels 4, and a rear panel (not shown) (FIG. 2 depicts the beverage machine absent the rear panel).

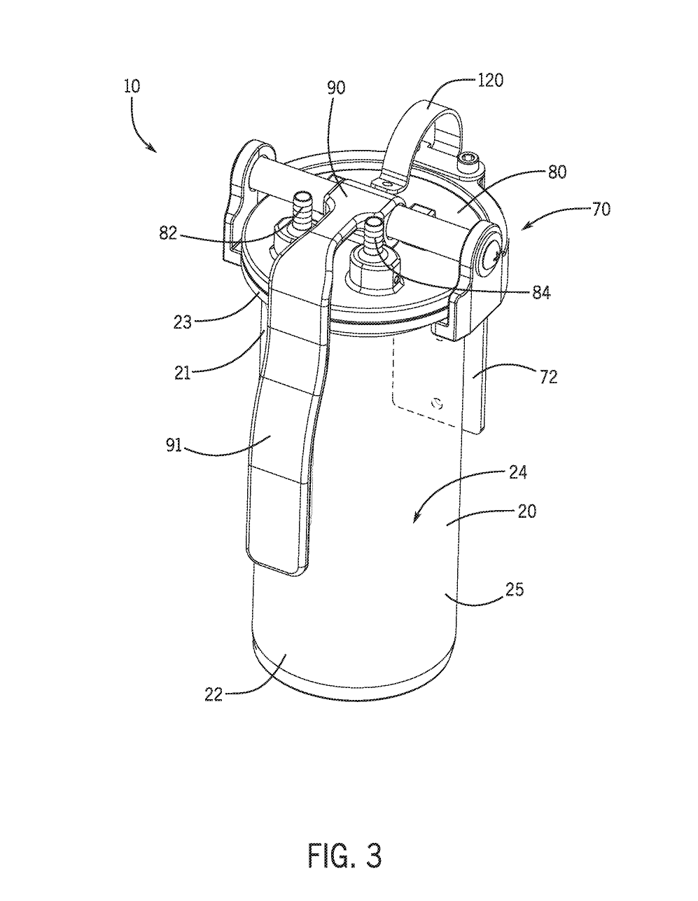

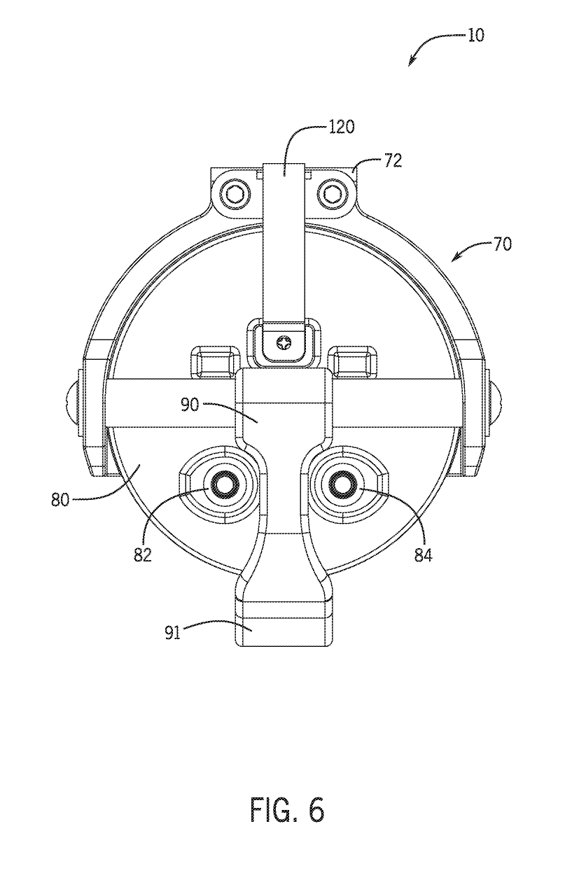

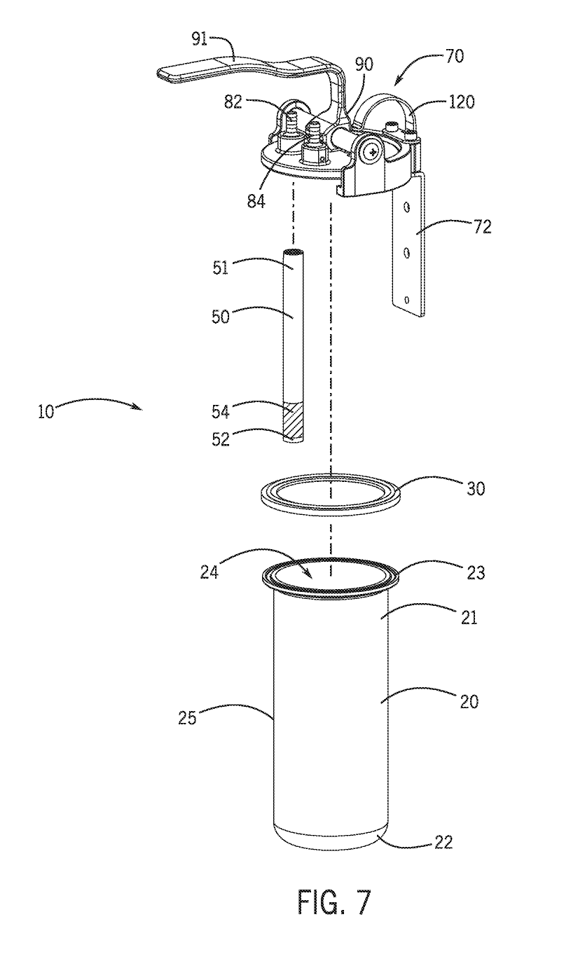

Referring to FIGS. 3-7, the gas dissolution assembly 10 includes a container or pressure vessel 20 configured to receive and contain the beverage into which the gas will be dissolved or infused. The pressure vessel 20 has an open end 21 and an opposite closed end 22. The pressure vessel 20 defines an interior space 24 (FIG. 7). The pressure vessel 20 can be transparent such that the operator can view the beverage contained by the pressure vessel 20. A peripheral flange 23 (FIG. 7) extends radially and peripherally around the open end 21. In certain examples, a flexible seal 30 (FIG. 7) can be included to cover the open end 21 of the pressure vessel 20. The flexible seal 30 can be porous to thereby allow gas to flow from the interior space 24 to a gas outlet 84 (described herein).

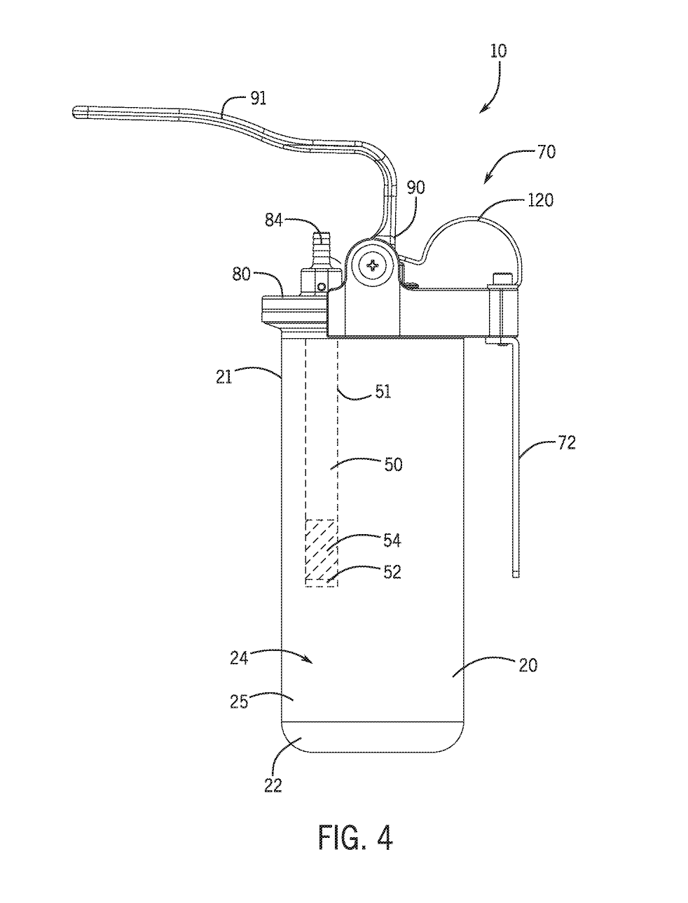

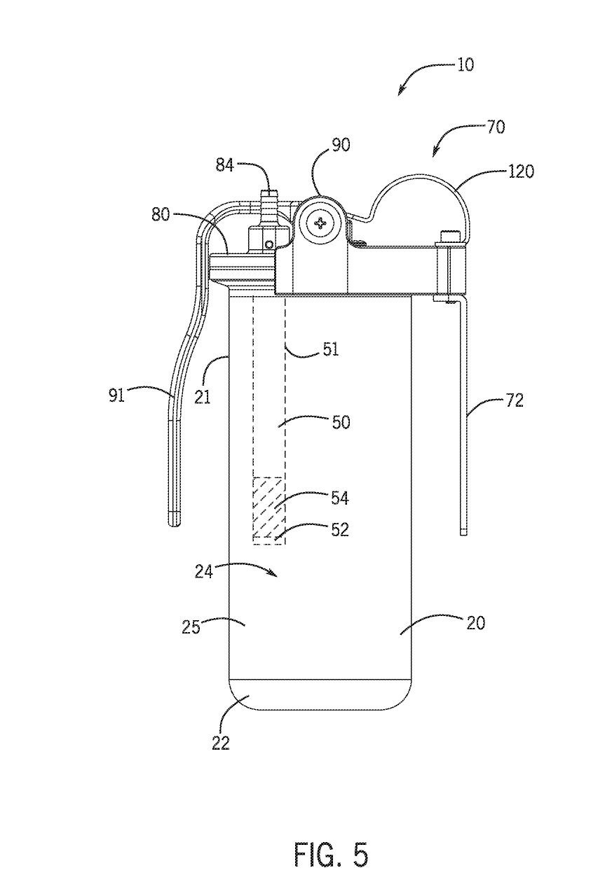

The gas dissolution assembly 10 includes a closure mechanism 70 having a retainer 72, a top cap 80, and a clamping mechanism 90. The clamping mechanism 90 is an over-center clamping mechanism 90 that is configured to efficiently and effectively clamp the top cap 80 onto the open end 21 of the pressure vessel 20. In example gas dissolution assemblies 10 that include the flexible seal 30, the flexible seal 30 is sandwiched between the top cap 80 and the open end 21 of the pressure vessel 20 (FIG. 7). The over-center clamping mechanism 90 includes a handle 91 that is movable into and between a clamped position (FIG. 5) wherein the over-center clamping mechanism 90 clamps the top cap 80 onto the open end 21 of the pressure vessel 20 and an unclamped position (FIG. 4) wherein the top cap 80 is unclamped from the open end 21 of the pressure vessel 20 such that the pressure vessel 20 can be removed from the retainer 72. A gas inlet 82 and a gas outlet 84 extend through the top cap 80 and facilitate flow of gas to and from the pressure vessel 20 via the gas inlet 82 and the gas outlet 84. The retainer 72 is mounted to the housing 2 and is configured to receive and retain the open end 21 of the pressure vessel 20 (FIG. 1). The gas dissolution assembly 10 also includes a resilient member 120 (FIG. 3) that tends to force the top cap 80 out of engagement with the pressure vessel 20. Reference is made to above-incorporated pending U.S. patent application Ser. No. 15/138,643 for further description of these features.

The gas dissolution assembly 10 advantageously includes a gas dissolution or infusing device 50 (FIG. 7) configured to dissolve or infuse the gas into the beverage. The gas infusing device 50 has a first end 51 and a second end 52 opposite the first end 51. The first end 51 is removably coupled to the gas inlet 82 of the top cap 80. In certain examples, the first end 51 includes a quick-connect mechanism or like mechanism that allows the operator to quickly detach the gas infusing device 50 from the top cap 80 for cleaning and maintenance. The gas infusing device 50 includes a porous element 54 that is configured to dissolve or infuse the gas from the gas inlet 82 into the beverage (i.e. the gas passes through the porous element 54 to be dissolved in the beverage). The position of the porous element 54 relative to the other components of the gas infusing device 50 can vary (e.g. the porous element 54 is positioned at the second end 52).

The porous element 54 has a plurality of pores defined therein, and relatively small bubbles of the gas permeate through the plurality of pores into the beverage such that the gas saturates and dissolves or infuses into the beverage. The pores can vary in size. In one example, the diameter of each pore is two microns. The present inventors have determined that locating the porous element 54 closer to the second end 52 than the first end 51 of the gas infusing device 50 allows the operator to dissolve or infuse gas into small amounts of beverage contained in the pressure vessel 20. Reference is made to U.S. Patent Application Publication No. 2017/0055552 for further description of dissolving or infusing gas in a liquid using a porous element 54.

The position of the gas infusing device 50 and/or the porous element 54 relative to the pressure vessel 20 can also vary from what is shown. Referring to FIGS. 4-5, the gas infusing device 50 is disposed in the interior space 24 of the pressure vessel 20 such that the porous element 54 is located nearer the closed end 22 of the pressure vessel 20 than the open end 21 of the pressure vessel 20.

In certain examples, the beverage machine 1 includes an agitation mechanism 92 (FIG. 2) that is configured to agitate the beverage in the interior space 24 to thereby increase dissolution or infusing of the gas into the beverage. Through research and experimentation, the present inventors have found it desirable to agitate the beverage by such that the beverage “scrubs” bubbles off of the porous element 54 as the beverage agitates. Reference is made to U.S. Pat. No. 9,114,368 for examples of agitators and agitation mechanism.

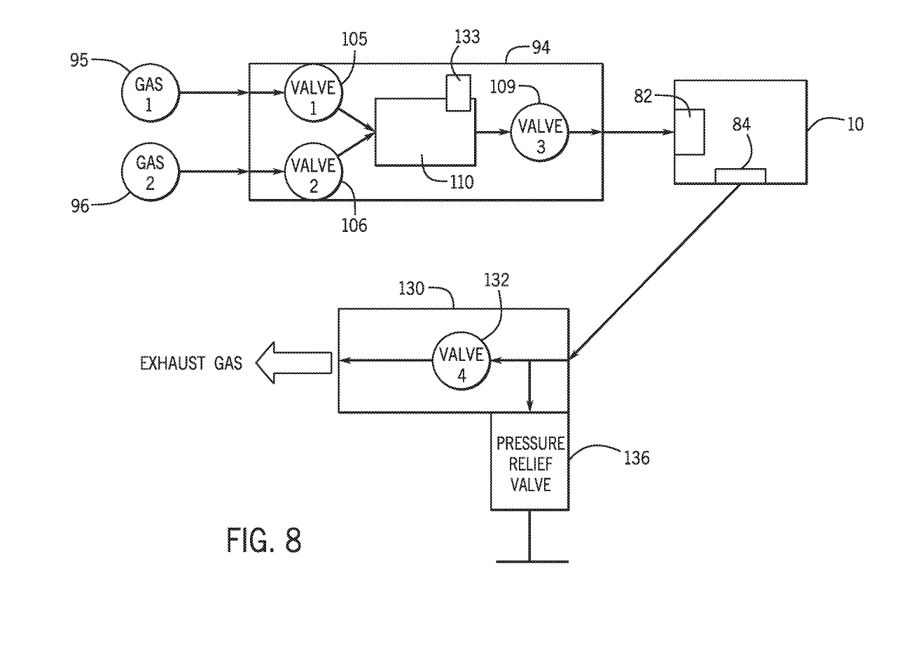

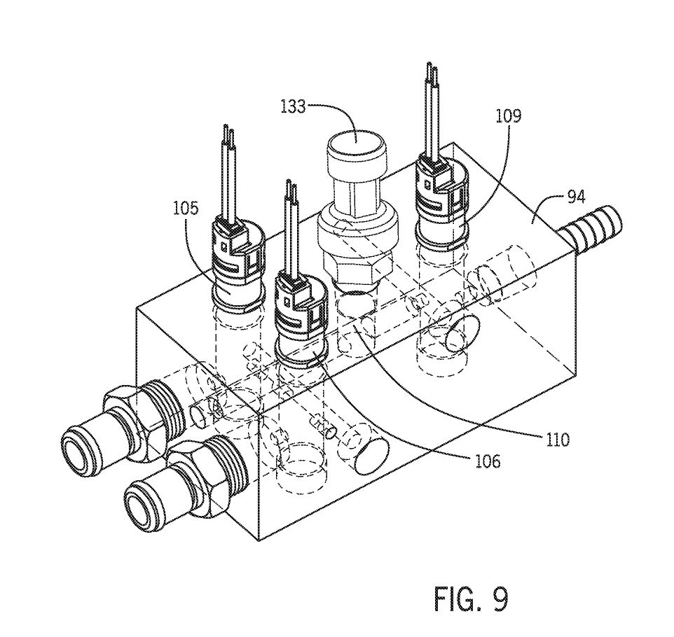

Referring to FIGS. 2 and 8-9, the beverage machine 1 includes an inlet gas manifold 94 that regulates the flow of gas to the gas inlet 82. The gas to be infused in the beverage is one of a first gas (e.g. carbon dioxide), a different second gas (e.g. nitrogen), and a mixed gas formed from the first gas and second gas. The inlet gas manifold 94 includes a first inlet valve 105 that receives the first gas from a first gas source 95, a second inlet valve 106 that receives the second gas from a second gas source 96, and an outlet valve 109 that dispenses a selected one of the first gas, the second gas, and the mixed gas to the gas inlet 82. The inlet gas manifold 94 also includes an inlet pressure sensor 133 (described further herein) that is configured to sense a pressure of the first gas received by the first inlet valve 105, a pressure of the second gas received by the second inlet valve 106, and/or a pressure of the gas in the pressure vessel 20. The number of gases and/or gas inlet valves can vary. The inlet gas manifold 94 can define a mixing chamber 110 that is configured to mix the first gas and the second gas to form the mixed gas. The valves 105, 106, 109 can be any suitable valve such as a solenoid valve, variable orifice valve, bullet valves, and/or the like. Example variable orifice valves are manufactured and commercially available from Cole-Parmer (Cole-Parmer Proportioning Solenoid Valve; ¼″ OD, 0-30 VDC, 0.063″, Model # PSV-4), Coast Pneumatics (EVP Proportional Valve, 0-20 VDC, 0.013″ Orifice, 100 psig, part number EV-PM-20-13A0), and Mac Valve.

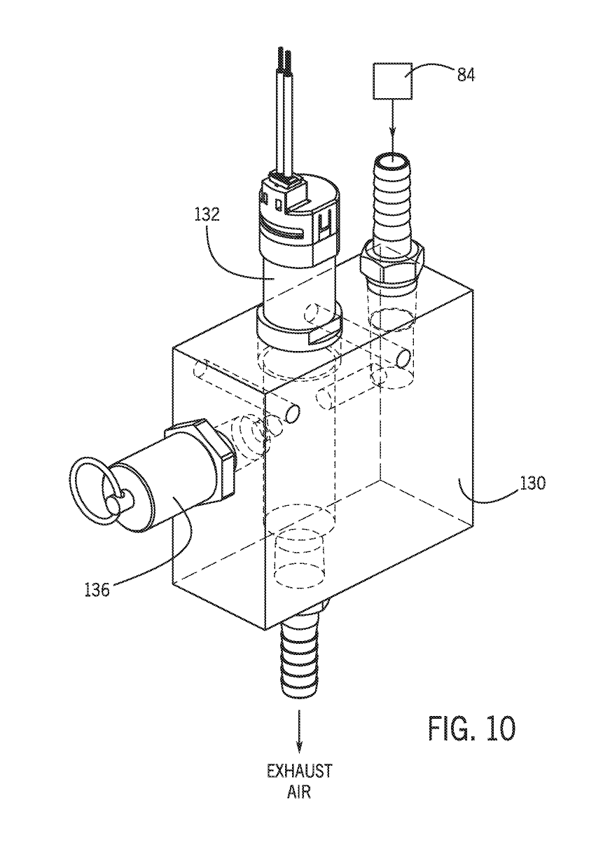

Referring to FIGS. 2, 8, and 10, the beverage machine 1 includes an outlet gas manifold 130 that regulates the flow of gas from the gas dissolution assembly 10. That is, the outlet gas manifold 130 is in communication with the gas outlet 84 of the top cap 80, receives gas from the gas outlet 84, and dispenses the gas to another container and/or the atmosphere. The outlet gas manifold 130 comprises a release valve 132 that receives gas from the pressure vessel 20. The release valve 132 is configured to selectively open to thereby release the gas from the pressure vessel 20 (FIG. 3) to the atmosphere. The outlet gas manifold 130 also includes a relief valve 136 configured to release the gas of the pressure from the pressure vessel 20 to the atmosphere. The relief valve 136 can be manually opened by an operator and/or configured to automatically open when the pressure of the gas is at a predetermined maximum pressure.

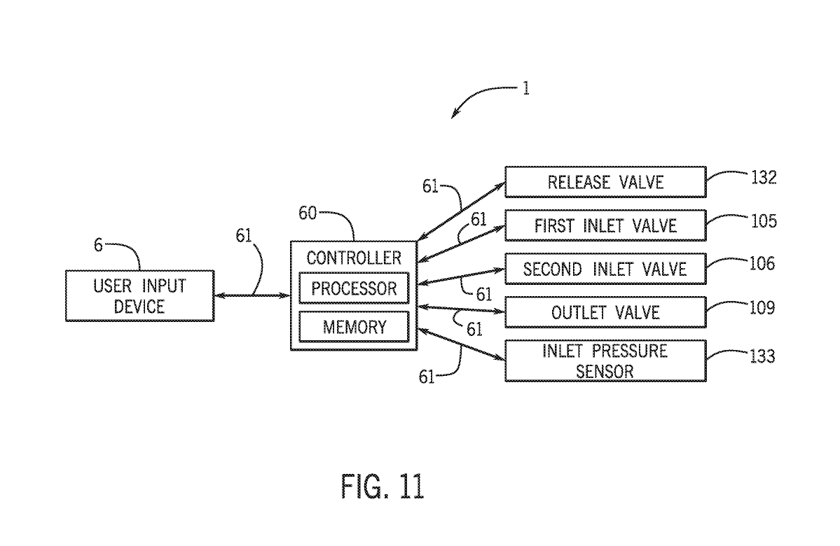

Referring to FIG. 11, the beverage machine includes a computer controller 60 in communication with various components of the beverage machine 1 described herein. The controller 60 controls the beverage machine 1 in accordance with inputs received by a user input device 6 that is positioned on the housing 2 (FIG. 1). The type and configuration of the user input device 6 and the controller 60 can vary from that which is shown. The user input device 6 can include one or more conventional input devices for inputting operator or user selections to the controller 60. Exemplary user input devices 6 include touch screens, mechanical buttons, mechanical switches, voice command receivers, tactile command receivers, gesture sensing devices, and/or remove controllers such as personal digital assistant(s) (PDAs), handheld(s), laptop computer(s), and/or the like.

The controller 60 can be located in beverage machine 1 and/or can be located remotely from beverage machine 1. In some examples, the controller 60 can be configured to communicate via the Internet or any other suitable communication link. Although FIG. 11 shows one controller 60, there can be more than one controller 60. Portions of the methods described herein can be carried out by a single controller or by several separate controllers. Each controller can have one or more control sections or control units. In some examples, the controller 60 can include a computing system that includes a processing system, storage system, software, and input/output (I/O) interfaces (e.g. user input device 6) for communicating with devices described herein and/or with other devices. The processing system can load and execute software from the storage system. The controller 60 may include one or many application modules and one or more processors, which may be communicatively connected. The processing system may comprise a microprocessor and other circuitry that retrieves and executes software from the storage system. Non-limiting examples of the processing system include general purpose central processing units, applications specific processors, and logic devices. The storage system can comprise any storage media readable by the processing system and capable of storing software. The storage system can include volatile and non-volatile, removable and non-removable media implemented in any method or technology for storage of information, such as computer readable instructions, data structures, program modules, or other data.

The controller 60 communicates with one or more components of the beverage machine 1 via one or more communication links 61, which can be a wired or wireless links. The controller 60 is capable of monitoring and/or controlling one or more operational characteristics of the beverage machine 1 and its various subsystems by sending and receiving control signals via the communication links 61. It should be noted that the extent of connections of the communication link 61 shown herein is for schematic purposes only, and the communication links 61 in fact provides communication between the controller 60 and each of the devices and various subsystems described herein, although not every connection is shown in the drawing for purposes of clarity.

The controller 60 is in communication with the user input device 6, the first inlet valve 105, and the second inlet valve 106, and the controller 60 is configured to selectively open the first inlet valve 105 and the second inlet valve 106 based on the input received by the user input device 6. Opening and/or closing of the inlet valves 105, 106 thereby regulates flow of the first gas and the second gas through the inlet gas manifold 94. The controller 60 is in further communication with the outlet valve 109, and the controller 60 is further configured to selectively open the outlet valve 109 to thereby regulate flow of gas to the gas inlet 82. In certain examples, the controller 60 may control the inlet valves 105, 106 simultaneously and/or alternately to achieve a selected gas ratio or gas mixture (i.e. the gas “pulses” as the valves 105, 106 are selectively opened and closed by the controller 60).

The controller 60 is in communication with inlet pressure sensor 133 and is configured to sense the pressure of the first gas received by the first inlet valve 105, the pressure of the second gas received by the second inlet valve 106, and/or the pressure of the gas in the pressure vessel 20. The controller 60 is configured to selectively open the first inlet valve 105 and the second inlet valve 106 based on the gas pressure sensed by the inlet pressure sensor 133 and/or the input received the user input device 6. The controller 60 is also configured to selectively open the release valve 132 based on the pressure sensed by the inlet pressure sensor 133. The controller 60 is further configured to selectively open the relief valve 136 when the pressure sensed by the inlet pressure sensor 133 is greater than a stored pressure. The stored pressure may be any value preprogrammed stored on the controller 60 that corresponds to a maximum gas pressure that can be accommodated by the beverage machine 1.

The present inventors have further discovered that calibrating the gas dissolution assembly 10 with the pressures of the gases coupled to the inlet gas manifold 94 maintains the consistency of gas dissolution in the beverages and allows the operators to use different types and pressures of gases (e.g. gas cylinder tanks, compressors, gas systems). Accordingly, the gas dissolution assembly 10 can be calibrated by sensing the gas pressures of each gas entering the inlet gas manifold 94. In operation, the valves 105, 106, 109 are initially closed such that first and second gases do not flow through inlet gas manifold 94. The first inlet valve 105 is opened such that the inlet pressure sensor 133 senses the gas pressure of the first gas. The inlet pressure sensor 133 relays a signal to the controller 60 that corresponds to the gas pressure of the first gas. The first inlet valve 105 is then closed, and the outlet valve 109 is opened and closed to release the gas pressure and/or vent the inlet gas manifold 94. Next, the second inlet valve 106 is opened such that the inlet pressure sensor 133 senses the gas pressure of the second gas. The second inlet valve 106 is then closed, and the outlet valve 109 is opened to release the gas pressure and/or vent the inlet gas manifold 94.

As briefly mentioned above, the inlet valves 105, 106 selectively open and close to create and convey a mixed gas comprising the first and second gases to the gas inlet 82 for dissolution into the beverage based on user inputs received by the user input device 6. The user input can include a gas ratio input (e.g. 80/20, 70/30, 60/40) of the mixed gas that corresponds to amounts of the gases relative to each other to be dissolved or infused into the beverage (e.g. 80 percent carbon dioxide and 20 percent nitrogen). In one example, the first inlet valve 105 is opened and the second inlet valve 106 is reciprocated or repeatably opened and closed such that the first and second gases mix to create the mixed gas having a user specified gas ratio (i.e. the second gas “pulses” into the first gas as the second inlet valve 106 is repeatable opened and closed). In another example, the first inlet valve 105 and the second inlet valve 106 are reciprocated or repeatably opened and closed such that the first and second gases mix to create the mixed gas. The first inlet valve 105 and the second inlet valve 106 can be repeatably opened and closed at the same or different rates.

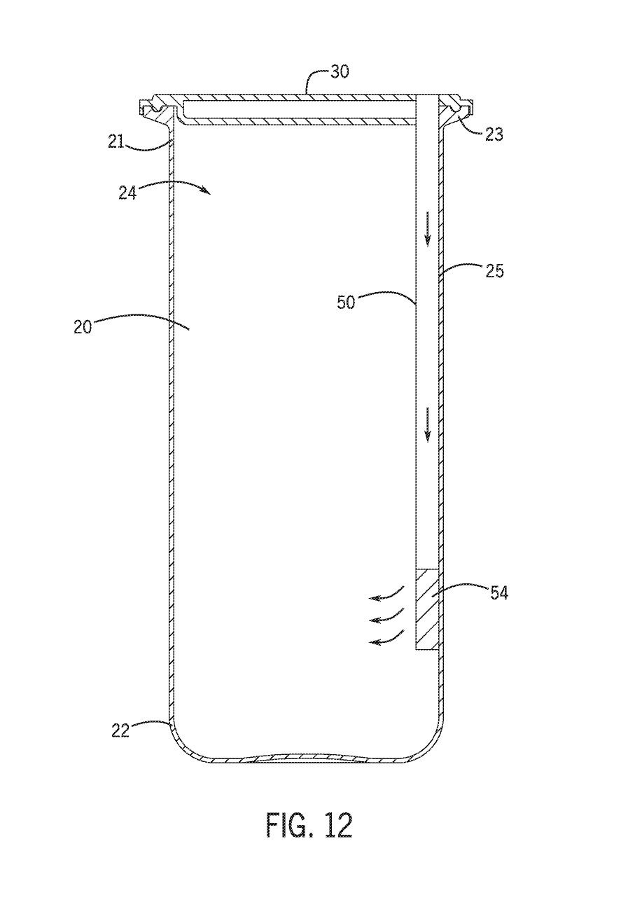

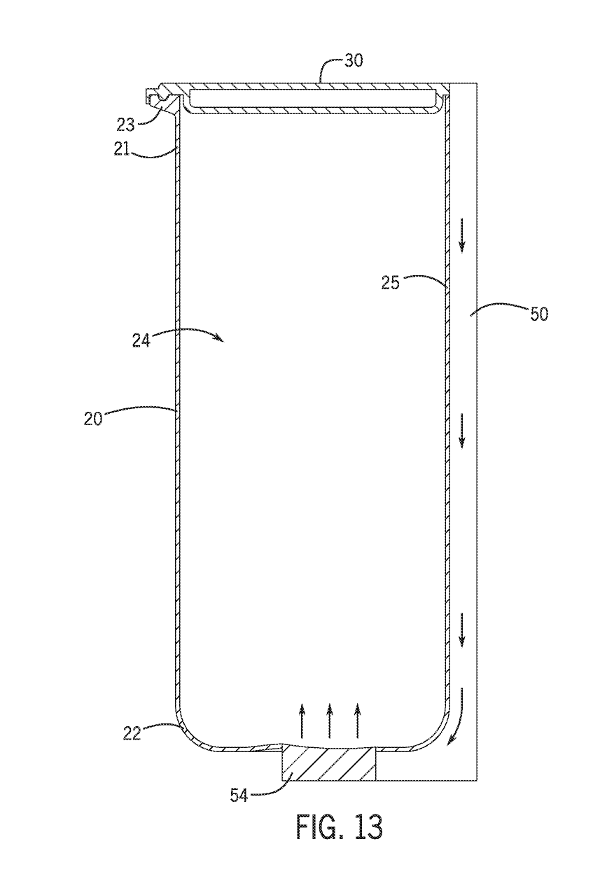

FIGS. 12-17 depict alternative examples of the pressure vessel 20 and the gas infusing device 50. Referring to FIG. 12, the pressure vessel 20 includes a perimeter sidewall 25, and the gas infusing device 50 is positioned in the interior space 24 of the pressure vessel 20 such that the gas infusing device 50 abuts the perimeter sidewall 25. The gas infusing device 50 is a conduit through which the gas from the gas inlet 82 (FIG. 3) flows to the porous element 54. Referring to FIG. 13, the gas infusing device 50 is positioned exterior to the interior space 24 of the pressure vessel 20 (i.e. coupled to the outer surface of the perimeter sidewall 25) such that the gas infusing device 50 abuts the perimeter sidewall 25 and the closed end 22 and the porous element is coupled to the closed end 22 of the pressure vessel 20. The shape and/or cross section of the gas infusing device 50 can vary (e.g. circular, cylindrical, rectangular). In certain examples, the gas infusing device 50 is integrally formed with the perimeter sidewall 25.

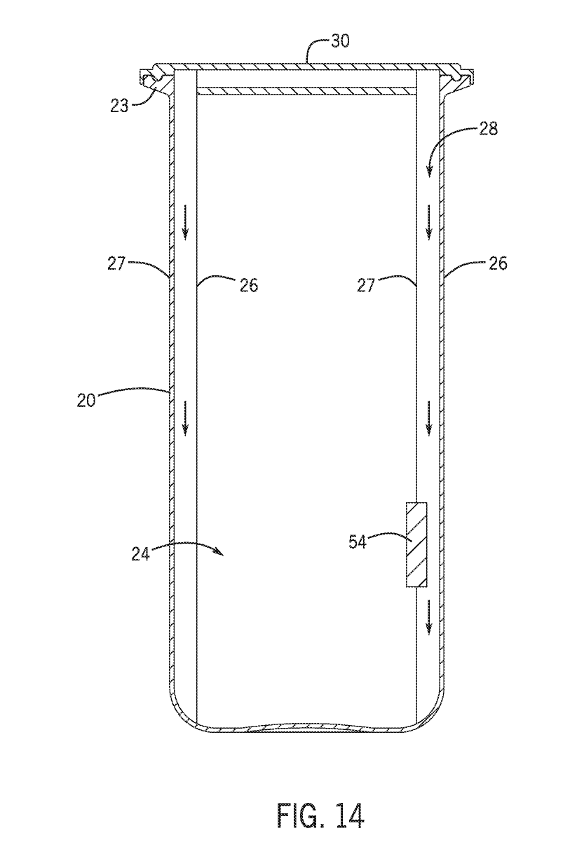

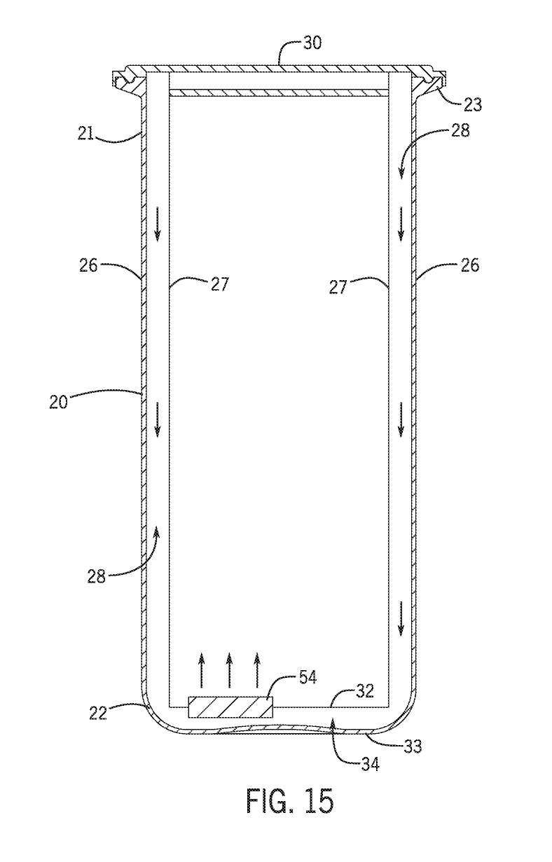

Referring to FIGS. 14-15, the pressure vessel 20 is a double-wall pressure vessel that includes an inner sidewall 26 and an outer sidewall 27. In these examples, the gas infusing device 50 (FIG. 4) is integrally formed or incorporated with the pressure vessel 20. The inner sidewall 26 and the outer sidewall 27 define a channel 28 that is configured to aligns with the with the gas inlet 82 (FIG. 3) such that the gas can flow from the gas inlet 82 (FIG. 3) to the porous element 54 which is coupled to the inner sidewall 26. The porous element 54 dissolves or infuses the gas into the beverage in the interior space 24 of the pressure vessel 20. The shape of the channel 28 can vary (e.g. circular, cylindrical, rectangular).

The example pressure vessel 20 depicted in FIG. 15 includes an inner bottom wall 32 and an outer bottom wall 33 at the closed end 22. The inner bottom wall 32 and the outer bottom wall 33 define a channel 34 that is in communication with the channel 28 defined between the inner sidewall 26 and the outer sidewall 27. The porous element 54 is coupled to the inner bottom wall 32 such that the porous element 54 dissolves or infuses the gas into the beverage in the interior space 24 of the pressure vessel 20.

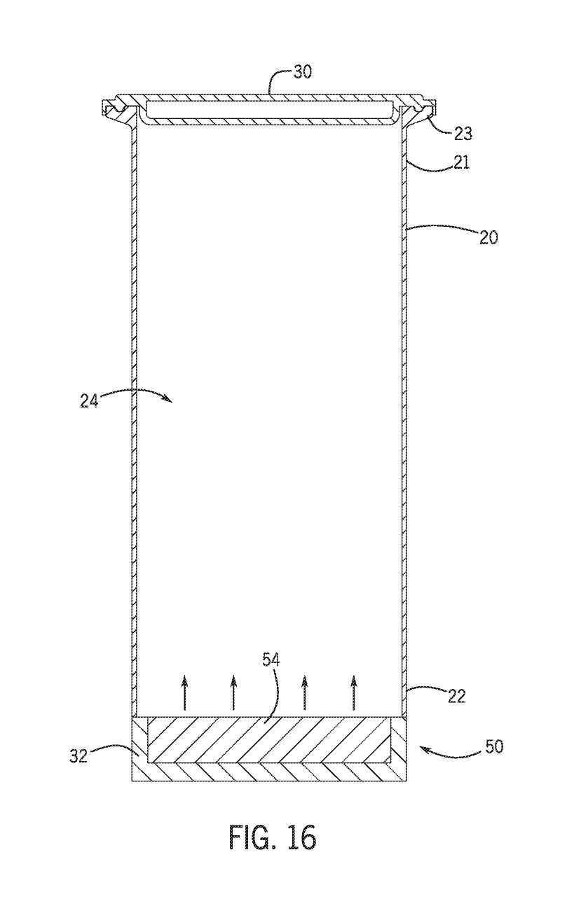

Referring to FIG. 16, the gas infusing device 50 is a detachable porous member 36 that is coupled to the closed end 22 of the pressure vessel 20. In operation, gas flows to the detachable porous member 36 via a channel, pipe, or tube (not shown) where the gas is dissolved or infused into the beverage in the interior space 24 of the pressure vessel 20. The closed end 22 can include an interface wall (not shown) that facilities connection to the detachable porous member 36 to the closed end 22. The detachable porous member 36 is similar to and includes features described above with reference to the porous element 54 (FIG. 3). The flexible seal 30 is porous and allows gas to convey through the flexible seal 30 to the gas outlet 84 (FIG. 3). The flexible seal 30 can be a flexible membrane constructed in accordance with the embodiments disclosed in the above-incorporated U.S. patent application, U.S. patent application Publications, and U.S. patent.

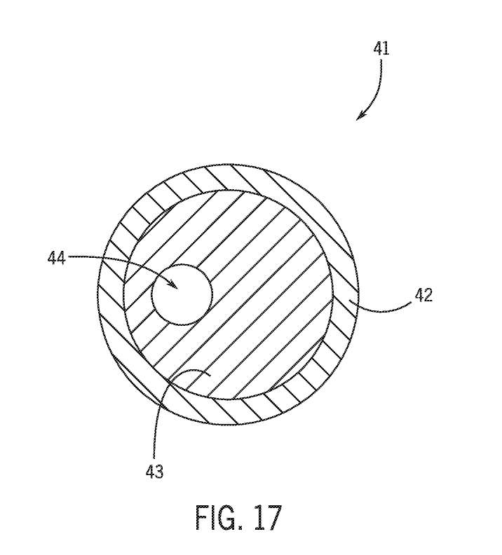

Referring to FIG. 17, an example gas pass-through device 41 is depicted. The gas pass-through device 41 is configured to removably couple to the gas infusing device 50 (FIG. 3) and cover the open end 21 of the pressure vessel 20 (FIG. 3). The gas pass-through device 41 includes an outer perimeteral surface 42 that is configured to be sandwiched between the peripheral flange 23 of the pressure vessel 20 and the top cap 80 and a porous or mesh inner surface 43. The mesh inner surface 43 defines an opening 44, and the gas infusing device 50 is coupled to the mesh inner surface 43 at the opening 44. In operation, the gas pass-through device 41 is positioned on the open end 21 of the pressure vessel 20 (FIG. 3) such that the gas infusing device 50 (FIG. 3) is in the interior space 24 defined by the pressure vessel 20 and aligned with the gas inlet 82. The outer perimeteral surface 42 is then sandwiched between the peripheral flange 23 of the pressure vessel 20 and the closure mechanism 70 (FIG. 3). The mesh inner surface 43 is configured to allow gas to flow there through to the gas outlet 84 (FIG. 3).

What is claimed is:

1. A gas dissolution assembly comprising:
a pressure vessel having an open end and being configured to contain a beverage into which a gas is infused;
a top cap having a gas inlet through which a gas to be infused into the beverage flows;
a clamping mechanism that clamps the top cap onto the open end of the pressure vessel; and
a gas infusing device coupled to the gas inlet and having a porous element that is configured to infuse the gas into the beverage.

2. The gas dissolution assembly according to claim 1, wherein the pressure vessel defines an interior space; and wherein the gas infusing device is disposed in the interior space.

3. The gas dissolution assembly according to claim 2, wherein the gas infusing device has a first end coupled to the gas inlet and a second end opposite the first end, and wherein the porous element is positioned nearer then second end than the first end.

4. The gas dissolution assembly according to claim 3, wherein the pressure vessel has a closed end opposite the open end, and wherein the porous element is positioned closer the closed end than the open end.

5. The gas dissolution assembly according to claim 4, wherein the pressure vessel has an inner sidewall and an outer sidewall opposite the inner sidewall, and wherein the porous surface is on the inner sidewall.

6. The gas dissolution assembly according to claim 4, wherein the pressure vessel has an inner sidewall, an outer sidewall opposite the inner sidewall, an inner bottom wall, and an outer bottom wall opposite the inner bottom wall, and wherein the porous surface is on the inner bottom wall.

7. The gas dissolution assembly according to claim 3, wherein the top cap has a gas outlet through which the gas flows from the pressure vessel.

8. The gas dissolution assembly according to claim 7, further comprising an agitation mechanism configured to agitate the beverage and thereby facilitate dissolution of the gas into the beverage.

9. The gas dissolution assembly according to claim 1, further comprising an inlet gas manifold that regulates a flow of the gas to the gas inlet.

10. The gas dissolution assembly according to claim 8, wherein the gas is one of a first gas, a different second gas, and a mixed gas formed from the first gas and the second gas; and wherein the inlet gas manifold has a first inlet valve that receives the first gas, a second inlet valve that receives the second gas, and an outlet valve that alternately dispenses one of the first gas, the second gas, and the mixed gas.

11. The gas dissolution assembly according to claim 10, wherein the inlet gas manifold has a mixing chamber configured to mix the first gas and the second gas to form the mixed gas.

12. The gas dissolution assembly according to claim 11, further comprising
a user input device configured to receive an input; and
a controller in communication with the user input device, the first inlet valve, and the second inlet valve, wherein the controller is configured to selectively open the first inlet valve and the second inlet valve based on the input received by the user input device to thereby regulate flow of the first gas and the second gas.

13. The gas dissolution assembly according to claim 12, wherein the controller is configured to selectively open the outlet valve to thereby regulate the flow of the gas via the outlet valve.

14. The gas dissolution assembly according to claim 13, wherein the inlet gas manifold has an inlet pressure sensor configured to sense a pressure of the first gas received by the first inlet valve and a pressure of the second gas received by the second inlet valve, and wherein the controller is in communication with the inlet pressure sensor and configured to selectively open the first inlet valve and the second inlet valve based on the pressures sensed by the inlet pressure sensor and the input received by the user input device.

15. The gas dissolution assembly according to claim 12, wherein the top cap has a gas outlet through which the gas flows from the pressure vessel; and further comprising an outlet gas manifold that regulates a flow of the gas from the pressure vessel, the outlet gas manifold comprising a release valve that receives the gas from the pressure vessel, wherein the release valve is configured to selectively open to thereby release the gas from the pressure vessel.

16. The gas dissolution assembly according to claim 15, wherein the inlet gas manifold has an inlet pressure sensor configured to sense the pressure of the gas in the pressure vessel, and wherein the controller is in communication with the inlet pressure sensor and is configured to open the release valve based on the pressure sensed by the inlet pressure sensor.

17. The gas dissolution assembly according to claim 16, wherein the outlet gas manifold has a relief valve configured to release the gas from the pressure vessel to the atmosphere.

18. A method of infusing a gas in a beverage, the method comprising:
receiving a beverage into which a gas is infused in a pressure vessel having an open end;
coupling a top cap to the open end of the pressure vessel with a clamping mechanism, the top cap having a gas inlet through which the gas flows; and
infusing the gas into the beverage with a gas infusing device that is coupled to the gas inlet and has a porous element configured to infuse the gas into the beverage.

19. The method according to claim 18, further comprising:
receiving a first gas and a second gas with an inlet gas manifold having a first inlet valve that receives the first gas and a second inlet valve that receives the second gas;
dispensing the gas from the inlet gas manifold to the gas inlet, the inlet gas manifold having an outlet valve that dispenses the gas;
receiving a user input with a user input device; and
controlling, with a controller, the first inlet valve, the second inlet valve, and the outlet valve based on the input received by the user input device to thereby infuse the gas into the beverage.

20. A method of calibrating a beverage machine that infuses a gas in a beverage, the method comprising:
receiving a first gas and a second gas with an inlet gas manifold having a first inlet valve that receives the first gas, a second inlet valve that receives the second gas, and an outlet gas valve configured to dispense the gas to be infused in the beverage;
opening the first gas valve;
sensing, with an inlet pressure sensor, the pressure of the first gas;
closing the first gas valve;
opening the second gas valve;
sensing, with the inlet pressure sensor, the pressure of the second gas;
closing the second gas valve; and
controlling, with a controller, the first inlet valve, the second inlet valve, and the outlet valve based on the pressure of the first gas sensed by the inlet pressure sensor and the pressure of the second gas sensed by the inlet pressure sensor.

21. The method according to claim 20, further comprising:
receiving a user input with a user input device; and
controlling, with the controller, the first inlet valve, the second inlet valve, and the outlet valve based on the input received by the user input device to thereby infuse the gas into the beverage.
